(19) United States
(12) Patent Application Publication
(10) Pub. No.: US 2019/0111821 A1
(43) Pub. Date: Apr. 18, 2019

(54) ASSIST GRIP

(71) Applicant: NIFCO AMERICA CORP., Canal Winchester, OH (US)

(72) Inventor: Yong Quan YU, Canal Winchester, OH (US)

(21) Appl. No.: 16/089,982

(22) PCT Filed: Mar. 28, 2017
(86) PCT No.: PCT/US17/24486

§ 371 Date: Sep. 28, 2018

Related U.S. Application Data
(60) Provisional application No. 62/313,989, filed on Mar. 28, 2016.

(51) Int. Cl. B60N 3/02

(52) U.S. Cl. CPC B60N 3/026; B60Y 2200/11; B60N 3/023

(57) ABSTRACT

An assist grip includes an outer tubular portion having first and second fitted portions; a first fixed end portion having a first body portion inserted into one end of the outer tubular portion and a first fitting end portion extending from the first body portion to engage the first fitted portion of the outer tubular portion; and a second fixed end portion having a second body portion inserted into another end of the outer tubular portion and a second fitting end portion extending from the second body portion to engage the second fitted portion of the outer tubular portion.

### FIELD OF THE INVENTION

The present invention relates to an improvement of an assist grip attached to a compartment of an automobile, more specifically, an interior of the automobile on the roof lining, and to be held by a passenger.

### BACKGROUND OF THE INVENTION

For an example of a conventional assist grip, PTL 1 is referred to. In FIG. 13A, a cross-sectional view of an assist grip of PTL 1 is shown. The assist grip of PTL 1 includes an outer tubular member 3 to be held by a passenger, a first divided body 1 to be inserted into one end of the outer tubular member 3, and a second divided body 2 to be inserted into another end of the outer tubular member 3.

In FIG. 13B, the first divided body 1 has a first fitting end portion 10 having a first base portion 11 and a first head portion 12, and the second divided body 2 has a second fitting end portion 20 to engage the first fitting end portion 10 of first divided body 1. Further, the first fitting end portion 10 has an elastic reinforcing member 4. The elastic reinforcing member 4 is integrally formed with a reinforcing fix portion 40, which has a C-shape to attach to a groove 13 of the first fitting end portion 10, on one end and a reinforcing lock portion 41 on another end. The elastic reinforcing member 4 further has a reinforcing elastic contact portion 42 between the reinforcing fix portion 40 and the reinforcing lock portion 41.

To assemble the assist grip of PTL 1, as shown in FIG. 13C, the first divided body 1 is inserted into one end of the outer tubular member 3, and the reinforcing lock portion 41 is locked to an inner surface of the outer tubular member 3. The second divided body 2 is inserted into another end of the outer tubular member 3. When the second fitting end portion 20 engages the first fitting end portion 10, the elastic reinforcing member 4 is deformed, the reinforcing elastic contact portion 42 elastically contacts the first fitting end portion 10, and the first fitting end portion 10 is pressed against the second fitting end portion 20. Thereby, an engagement between first fitting end portion 10 and the second fitting end portion 20 is secured through the elastic reinforcing member 4 and the assist grip is assembled accordingly.

### CITATION LIST

### Patent Document

PTL 1: Japanese Patent Publication No. 2008-068748

### SUMMARY OF THE INVENTION

### Problems to be Solved by the Invention

In a structure of the assist grip in PTL 1 wherein the first fitting end portion 10 is directly connected to the second fitting end portion 20, the engagement between the first and second fitting end portions 10, 20 cannot be observed when fitting the first fitting end portion 10 and the second fitting end portion 20 to each other, as shown in FIG. 13A. Therefore, the first and second fitting end portions 10, 20 may be engaged poorly inside the outer tubular member 3. In addition, the assist grip in PTL 1 requires many components such as the elastic reinforcing member 4; therefore, the manufacturing cost of the assist grip in PTL 1 is high.

Therefore, the present invention is made in view of the aforementioned problems that a conventional technology has, and an object of the present invention is to provide an assist grip having a high assembly performance and a capability to tightly fit, and to reduce the manufacturing cost.

Further objects and advantages of the present invention will be apparent from the following description of the present invention.

### Means for Solving the Problems

In order to obtain the aforementioned object, in the present invention, an assist grip includes an outer tubular portion having first and second fitted portions; a first fixed end portion having a first body portion inserted into one end of the outer tubular portion and a first fitting end portion extending from the first body portion to engage the first fitted portion of the outer tubular portion; and a second fixed end portion having a second body portion inserted into another end of the outer tubular portion and a second fitting end portion extending from the second body portion to engage the second fitted portion of the outer tubular portion.

According to such configuration, the fitted portion is formed on the outer tubular portion for firm engagement. Further, the assembly requires two components so that the cost is reduced.

Another aspect of the present invention is that the outer tubular portion further includes a guide portion formed inside thereof extending from the one end toward said another end along an axis of the outer tubular portion, and the first or second body portion further includes an engaging portion corresponding to the guide portion.

According to such configuration, the first or second fixing end portion can be guided in an insertion direction during assembly to increase the assembly performance.

Another aspect of the present invention is that the first and second fitted portions are formed on the guide portion.

According to such configuration, the assembly performance is increased.

Another aspect of the present invention is that the first and second fitted portions are disposed at predetermined positions corresponding to the first and second fitting end portions.

According to such configuration, there are two fitted portions to increase the assembly performance and for firm engagement.

Another aspect of the present invention is that the first and second fitting end portions each has a hole portion corresponding to the first and second fitted portions of the outer tubular portion.

According to such configuration, the first and second fixed end portions are firmly engaged to the outer tubular portion and the assembly performance is increased.

Another aspect of the present invention is that the outer tubular portion further comprises a pair of auxiliary guide portions formed inside thereof extending along the axis of the outer tubular portion from the one end toward the another end of the outer tubular portion, and the first or second body portion includes an auxiliary engaging portion corresponding to the auxiliary guide portion so that the pair of auxiliary guide portions guides the first or second body portion when the first or second body portion is inserted into the outer tubular portion.

According to such configuration, the first or second fixing end portion can be guided in an insertion direction during assembly to increase the assembly performance and for firm engagement.

### Effect of the Invention

According to the aforementioned structures, the first and second fixed end portions having first and second fitting end portions formed at the ends respectively can fit to the respective fitted portions formed in the outer tubular portion of the handle. Thereby, the assembly performance is increased, the manufacturing cost is reduced and the fitting is firm.

The heretofore described and other objects, features, and advantages of the present invention will be clarified by the following description relating to the attached drawings illustrating preferred embodiments as examples of the invention.

### BRIEF DESCRIPTION OF THE DRAWINGS

FIG. 1 is a rear view of an assist grip of an embodiment of the present invention.

FIG. 2 is an exploded view of the assist grip of the embodiment.

FIG. 3A is a perspective view of a first base portion of the assist grip of the present embodiment, FIG. 3B is another perspective view thereof, and FIG. 3C is a rear view thereof.

FIG. 4A is a cross-sectional view thereof along the line 4A-4A in FIG. 3C, and FIG. 4B is a cross-sectional view thereof along the line 4B-4B in FIG. 3C.

FIG. 5A is a perspective view of a second base portion of the assist grip of the present embodiment, FIG. 5B is another perspective view thereof, and FIG. 5C is a rear view thereof.

FIG. 6A is a cross-sectional view thereof along the line 6A-6A in FIG. 5C, and FIG. 6B is a cross-sectional view thereof along the line 6B-6B in FIG. 5C.

FIG. 7A is a perspective view of a hinge portion of the assist grip of the embodiment, and FIG. 7B is another perspective view thereof.

FIG. 8A is a perspective view of an outer tubular portion of the assist grip of the present embodiment; FIG. 8B is another perspective view thereof, and FIG. 8C is a front view thereof.

FIG. 9A is a cross-sectional view thereof along the line 9A-9A in FIG. 8B, FIG. 9B is a cross-sectional view thereof along the line 9B-9B in FIG. 8C, FIG. 9C is a cross-sectional view thereof along the line 9C-9C in FIG. 8C, and FIG. 9D is a cross-sectional view thereof along the line 9D-9D in FIG. 8C.

FIG. 10A shows a front view of the first and second base portions of the assist grip of the present embodiment assembled with the outer tubular portion, FIG. 10B shows a plan view thereof, and FIG. 10C shows a left view thereof.

FIG. 11A is a cross-sectional view thereof along the line 11A-11A in FIG. 10A; FIG. 11B is a cross-sectional view thereof along the line 11B-11B in FIG. 10A; and FIG. 11C is a cross-sectional view thereof along the line 11C-11C in FIG. 10B.

FIG. 12 shows the components forming the handle portion of the assist grip of the present embodiment.

FIG. 13A is a cross-sectional view of a conventional assist grip, FIG. 13B is a partial cross-sectional view of the conventional assist grip before engagement, and FIG. 13C is the partial cross-sectional view of the conventional assist grip after engagement.

### DETAILED DESCRIPTION OF THE EMBODIMENTS

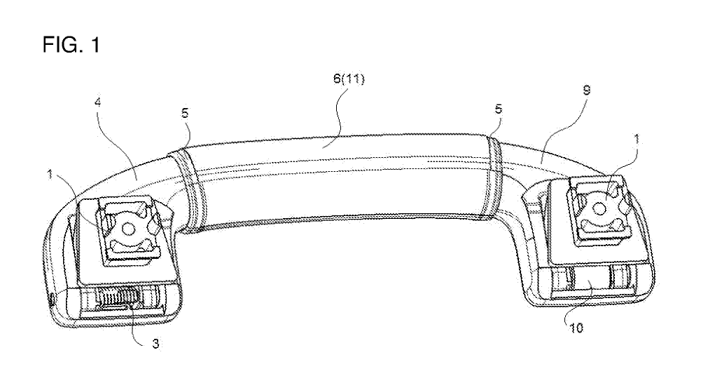

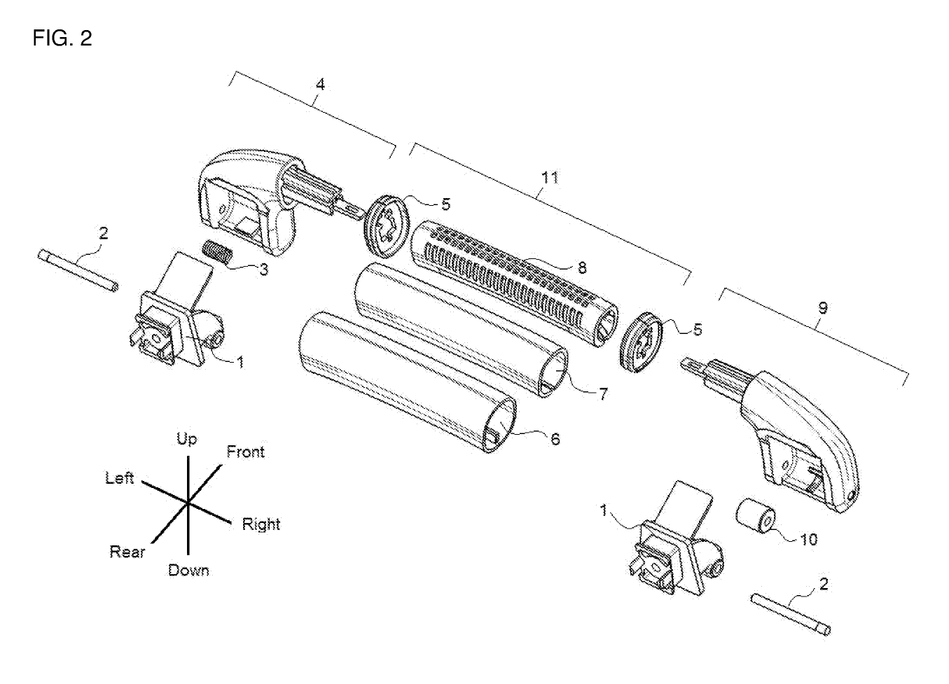

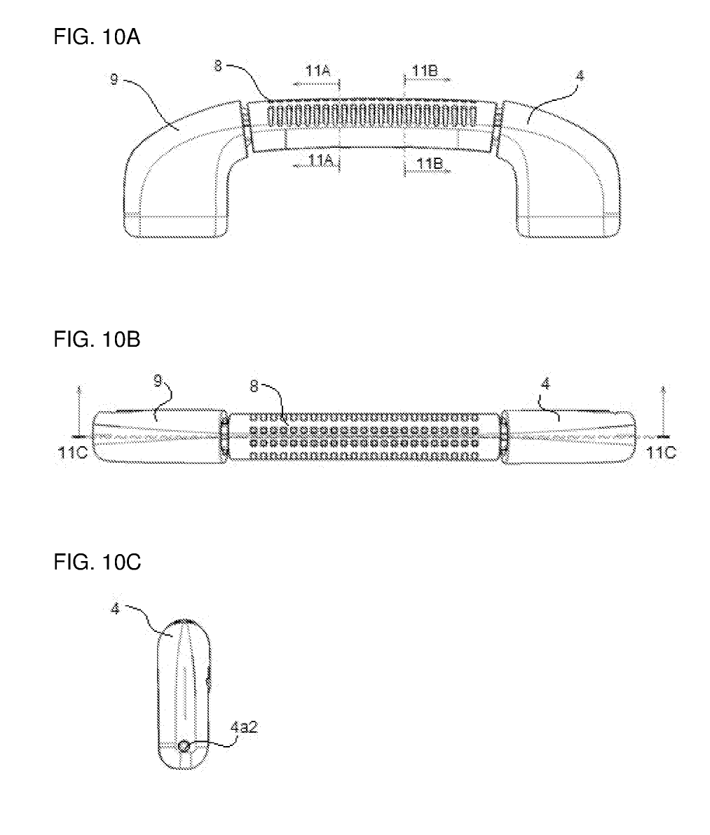

Hereinafter, an embodiment for carrying out the invention is described based on FIGS. 1-12. In an explanation, terms indicating the directions follow the directions shown by direction key in FIG. 2. However, an arrangement of the assist grip according to the present embodiment is not limited to the aforementioned directions.

The assist grip according to the embodiment of the present invention includes two hinge portions 1, two shaft portions 2, an urging member (hereinafter “spring”) 3, a first base portion 4, two ring portions 5, a second base portion 9, a damper device 10, and a handle portion 11, as shown in FIGS. 1 and 2.

The first base portion 4 is described in details.

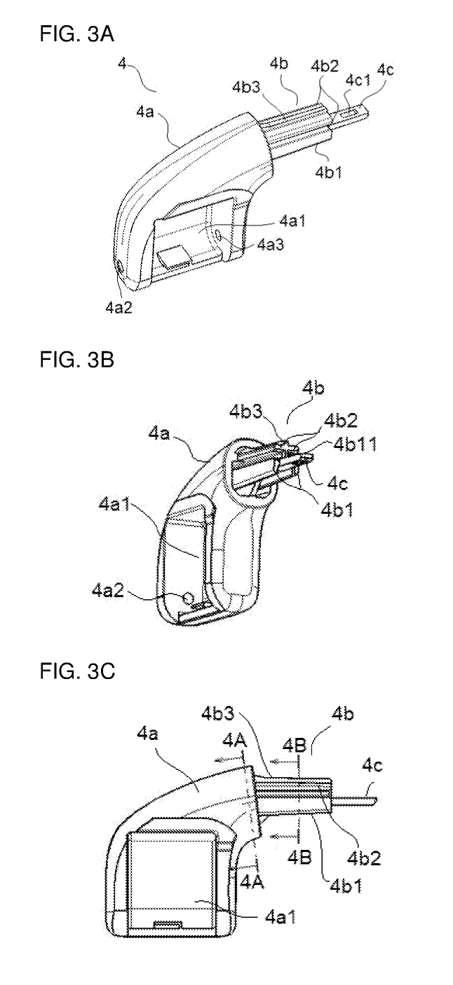

As shown in FIGS. 2-3C, the first base portion 4 includes a first fixed end portion 4a, a first body portion 4b extending from one end portion of the first fixed end portion 4a toward a right direction, and a first fitting end portion 4c extending from the first body portion 4b further toward the right direction to engage the handle portion 11. As shown in FIGS. 3A-3C, the first base portion 4 has an L-shape in which the first body portion 4b and the first fitting end portion 4c are integrally formed to the first fixed end portion 4a.

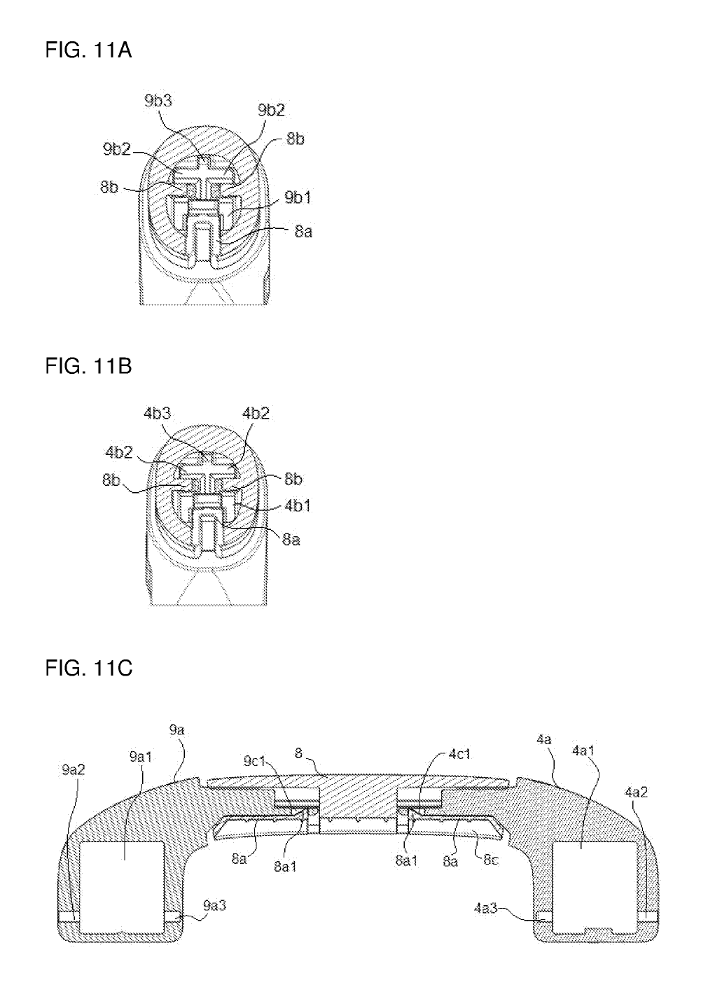

As shown in FIG. 3A, the first fixed end portion 4a of the first base portion 4 is formed with a concave portion 4a1 on a rear surface side to receive the hinge portion 1. Further, as shown in FIGS. 3A and 11C, a shaft through-hole 4a2 is formed on the left sidewall and a shaft hole 4a3 is formed on an inner surface of the right sidewall of the first fixed end portion 4a. The shaft portion 2 is inserted from the shaft through-hole 4a2 into the shaft hole 4a3 and press fitted to rotatably support the first base portion 4 relative to the hinge portion 1.

As shown in FIGS. 3B and 3C, the first body portion 4b extending from the first fixed end portion 4a includes a first engaging portion 4b1, a center portion 4b11 protruding upwardly from the first engaging portion 4b1, a pair of first auxiliary engaging portions 4b2 protruding in front and rear directions at an upper end of the center portion 4b11, a first top protruding portion 4b3 protruding upward from the pair of first auxiliary engaging portions 4b2, and a first fitting end portion 4c extending in the right direction.

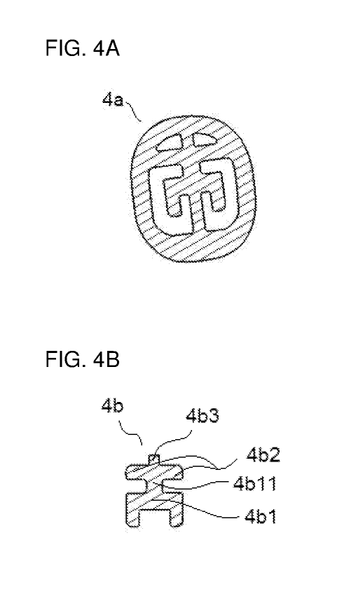

The first engaging portion 4b1 has an elongated plate portion extending along an axis of the first body portion 4b and two leg portions extending downward from two edges of the elongated plate portion along the axis of the first body portion 4b, as shown in FIG. 3B. The two leg portions of the first engaging portion 4b1 forms a space therebetween having a predetermined width corresponding to a width of a guide portion 8a of an outer tubular portion (hereinafter “tubular portion”) 8 of the handle portion 11 so that when the first base portion 4 is inserted into the handle portion 11, the first engaging portion 4b1 is guided along the guide portion 8a for easier assembly, as shown in FIGS. 4B and 11B.

At an upper end of the center portion, the pair of first auxiliary engaging portions 4b2 extends in the front and rear directions and along the axis of the first body portion 4b. In other words, one of the pair of first auxiliary engaging portions 4b2 extends toward the rear direction and along the axis, and the other of the pair of first auxiliary engaging portions 4b2 extends toward the front direction and along the axis. As shown in FIGS. 3B and 4B, a predetermined space is formed between the pair of first auxiliary engaging portions 4b2 and the elongated plate portion of the first engaging portion 4b1 to correspond to a width of an auxiliary guide portion 8b of the tubular portion 8 of the handle portion 11 so that when the first base portion 4 is inserted into the handle portion 11, the pair of first auxiliary engaging portions 4b2 is guided along the auxiliary guide portion 8b for easier assembly, as shown in FIG. 11B.

The first top protruding portion 4b3 is a protrusion extending upwardly from the pair of first auxiliary engaging portion 4b2 and elongated along the axis of the first body portion 4b, as shown in FIGS. 2 and 3A-3C. The first top protruding portion 4b3 is formed at a center of the pair of first auxiliary guided portion 4b2 so that when the first base portion 4 is inserted into the handle portion 11 through the ring portion 5, the first top protruding portion 4b3 is guided along a portion of the hole of the ring portion 5 having a shape corresponding to that of the first top protruding portion 4b3, as shown in FIG. 2.

The first fitting end portion 4c is formed to be elastically deformable and extends from a free end of the first body portion 4b as shown in FIGS. 3A-3C. More specifically, the first fitting end portion 4c extends from the elongated plate portion of the first engaging portion 4b1 towards the right direction, as shown in FIGS. 2 and 3A-3C. As shown in FIG. 11C, a leading end of the first fitting end portion 4c has an inclined surface formed at a bottom surface to slide along an inclined surface of one of two fitted portions 8a1 (first fitted portion) of the tubular portion 8. Further, the first fitting end portion 4c includes a hole portion 4c1 to engage the first fitted portion 8a1 of the tubular portion 8, thereby, the first base portion 4 engages to the tubular portion 8, as shown in FIGS. 3A and 11C.

The second base portion 9 is described.

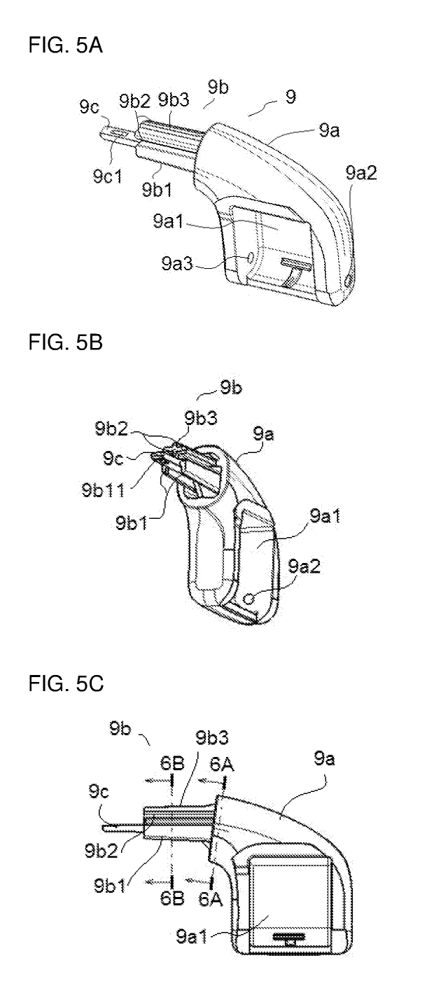

As shown in FIGS. 2 and 5A-5C, the second body portion 9 has a structure similar to the first body portion 4, but symmetrical to the first body portion 4. Therefore, the second body portion 9 includes a second fixed end portion 9a, a second body portion 9b extending from one end portion of the second fixed end portion 9a toward a left direction, and a second fitting end portion 9c extending from the second body portion 9b further toward the left direction to engage the handle portion 11. As shown in FIGS. 5A-5C, the second base portion 9 has an L-shape in which the second body portion 9b and the second fitting end portion 9c are integrally formed to the second fixed end portion 9a.

Similar to the first fixed end portion 4a, as shown in FIG. 5A, the second fixed end portion 9a of the second base portion 9 is also formed with a concave portion 9a1 on a rear surface side to receive the hinge portion 1. Further, a shaft through-hole 9a2 is formed on the right sidewall and a shaft hole 9a3 is formed on an inner surface of the left sidewall of the second fixed end portion 9a. The shaft portion 2 is inserted from the shaft through-hole 9a2 into the shaft hole 9a3 and press fitted to rotatably support the second base portion 9 relative to the hinge portion 1.

As shown in FIGS. 5B and 5C, the second body portion 9b extending from the second fixed end portion 9a includes a second engaging portion 9b1, a center portion 9b11 protruding upwardly from the second engaging portion 9b1, a pair of second auxiliary engaging portions 9b2 protruding in front and rear directions at an upper end of the center portion 9b11, a second top protruding portion 9b3 protruding upward from the pair of second auxiliary engaging portions 9b2, and a second fitting end portion 9c extending in the left direction.

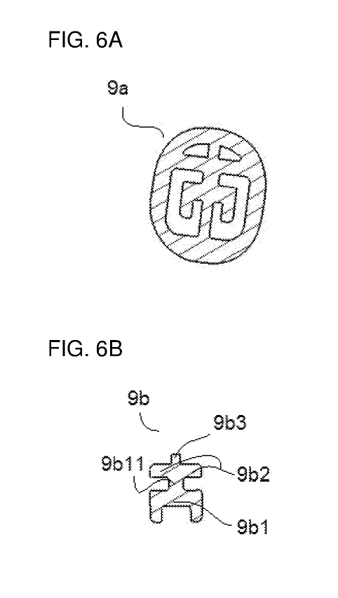

The second engaging portion 9b1 has an elongated plate portion extending along an axis of the second body portion 9b and two leg portions extending downward from two edges of the elongated plate portion along the axis of the second body portion 9b, as shown in FIG. 5B. The two leg portions of the second engaging portion 9b1 forms a space therebetween having a predetermined width corresponding to the width of the guide portion 8a of the tubular portion 8 of the handle portion 11 so that when the second base portion 9 is inserted into the handle portion 11, the second engaging portion 9b1 is guided along the guide portion 8a for easier assembly, as shown in FIGS. 6B and 11A.

At an upper end of the center portion, the pair of second auxiliary engaging portions 9b2 extends in the front and rear directions and along the axis of the second body portion 9b. In other words, one of the pair of second auxiliary engaging portions 9b2 extends toward the rear direction and along the axis, and another of the pair of second auxiliary engaging portions 9b2 extends toward the front direction and along the axis. A predetermined space is formed between the pair of second auxiliary engaging portions 9b2 and the elongated plate portion of the second engaging portion 9b1 to correspond to the width of the auxiliary guide portion 8b of the tubular portion 8 of the handle portion 11 so that when the second base portion 9 is inserted into the handle portion 11, the pair of second auxiliary engaging portions 9b2 is guided along the auxiliary guide portion 8b for easier assembly, as shown in FIG. 11A.

The second top protruding portion 9b3 is a protrusion extending upwardly from the pair of second auxiliary engaging portion 9b2 and elongated along the axis of the second body portion 9b, as shown in FIGS. 2 and 5A-5C. The second top protruding portion 9b3 is formed at a center of the pair of second auxiliary guided portion 9b2 so that when the second base portion 9 is inserted into the handle portion 11 through the ring portion 5, the second top protruding portion 9b3 is guided along a portion of the hole of the ring portion 5 having a shape corresponding to that of the second top protruding portion 9b3, as shown in FIG. 2.

The second fitting end portion 9c is formed to be elastically deformable and extends from a free end of the second body portion 9b as shown in FIGS. 5A-5C. More specifically, the second fitting end portion 9c extends from elongated plate portion of the second engaging portion 9b1 towards the left direction, as shown in FIGS. 2 and 5A-5C. As shown in FIG. 11C, a leading end of the second fitting end portion 9c has an inclined surface formed at a bottom surface to slide along an inclined surface of another of the two fitted portions 8a1 (a second fitted portion) of the tubular portion 8. Further, the second fitting end portion 9c includes a hole portion 9c1 to engage the second fitted portion 8a1 of the tubular portion 8, thereby, the second base portion 9 engages to the tubular portion 8, as shown in FIGS. 5A and 11C.

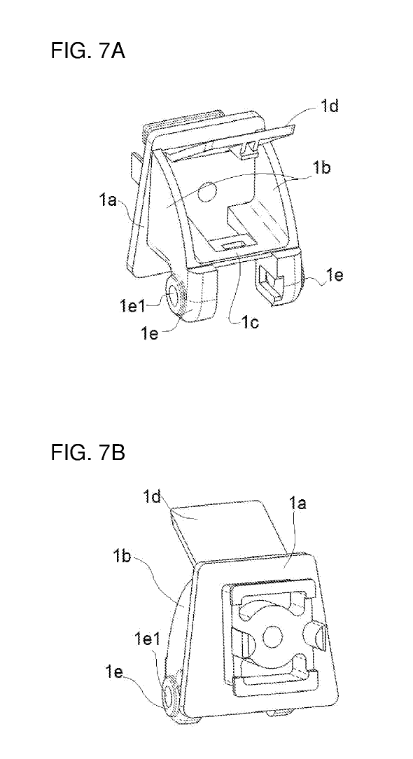

The hinge portion 1 is described in details, as shown in FIGS. 7A-7B.

The hinge portions 1 are fixed to a wall of a compartment of an automobile and are housed in the first base portion 4 and second base portion 9, as shown in FIGS. 1-2. The hinge portion 1 includes a plate portion 1a, a pair of sidewall portions 1b spaced away from each other and extending from the plate portion 1a, a bottom portion 1c connecting bottom ends of the pair of sidewall portions 1b, a top portion 1d formed between top ends of the pair of sidewall portions 1b, and a pair of leg portions 1e formed below the bottom portion 1c.

As shown in FIGS. 7A-7B, the pair of leg portions 1e each has a shaft hole 1e1 for inserting the shaft portion 2. The pair of leg portions 1e is arranged to have a space therebetween for fitting either the spring 3 or the damping device 10. In the present embodiment, the hinge portion 1 housed in the concave portion 4a1 of the first fixed end portion 4a is arranged with the spring 3 between the pair of leg portions 1e and the shaft portion 2 inserted therethrough, as shown in FIGS. 1-2. The spring 3 urges the first base portion 4 in a rotational direction of the assist grip. On the other hand, the hinge portion 1 housed in the concave space 9a1 of the second fixed end portion 9a is arranged with the damper device 10 between the pair of leg portions 1e and the shaft portion 2 inserted therethrough, as shown in FIGS. 1-2. Through such structure, when the spring 3 applies a rotational force to urge the assist grip in the rotational direction of the assist grip, the damping device 10 applies a resistance force against the spring 3 to dampen the rotational force of the assist grip; thereby, providing a sense of luxury.

The handle portion 11 is described in details.

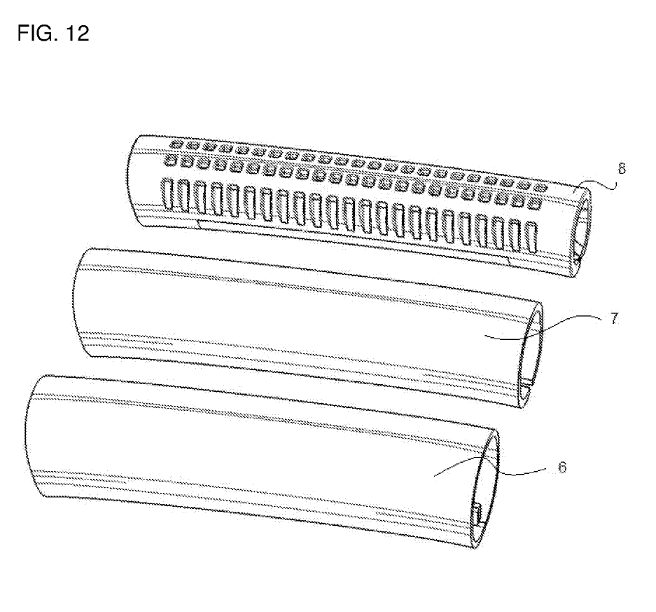

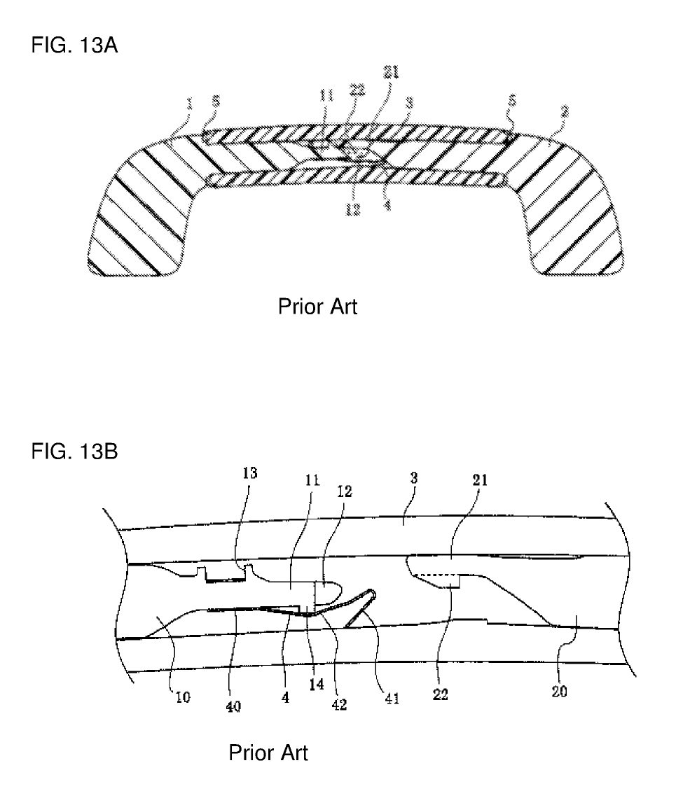

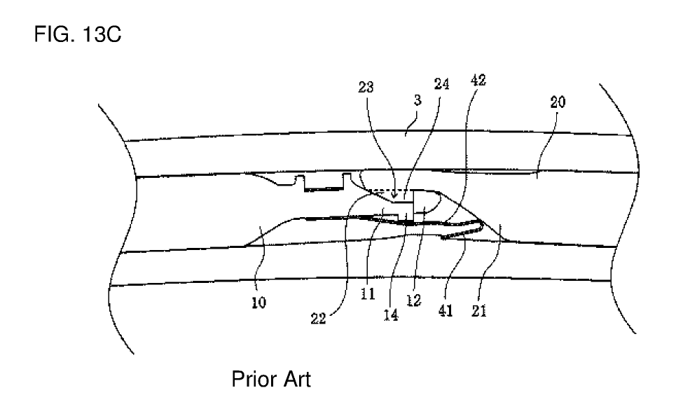

As shown in FIGS. 2 and 12, the handle portion 11 to be held by a passenger includes the tubular portion 8, a cushioning portion 7 surrounding the tubular portion 8, an outer cover portion 6 covering the cushioning portion 7, and a ring portion 5.

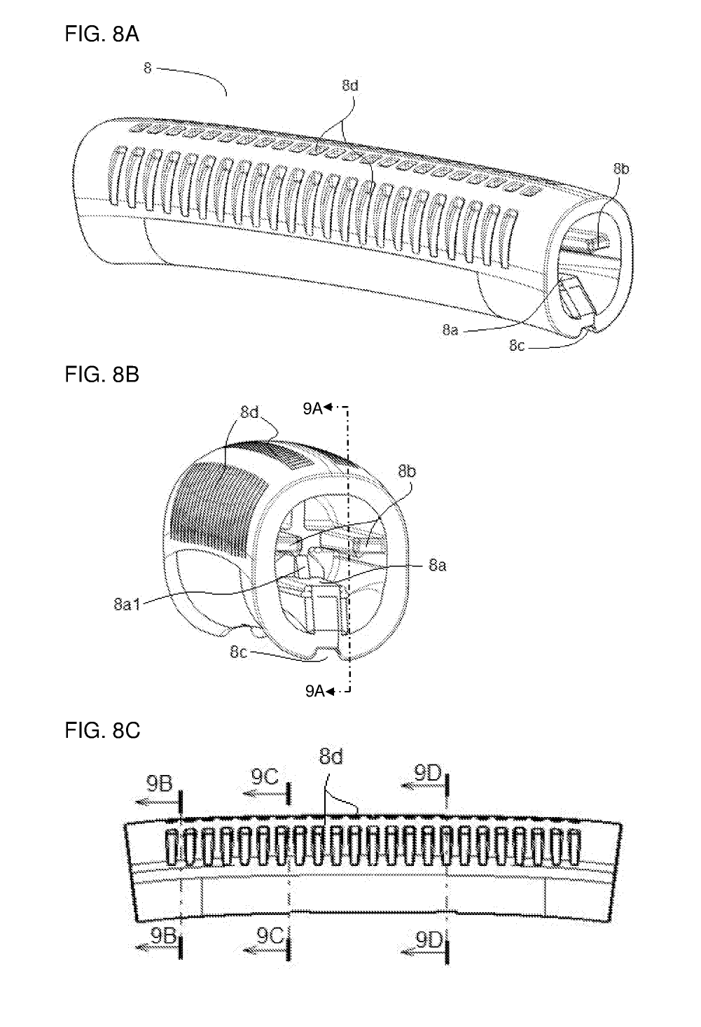

The tubular portion 8 has the guide portion 8a, the auxiliary guide portion 8b, and a plurality of ribs 8d, as shown in FIGS. 8A-8C.

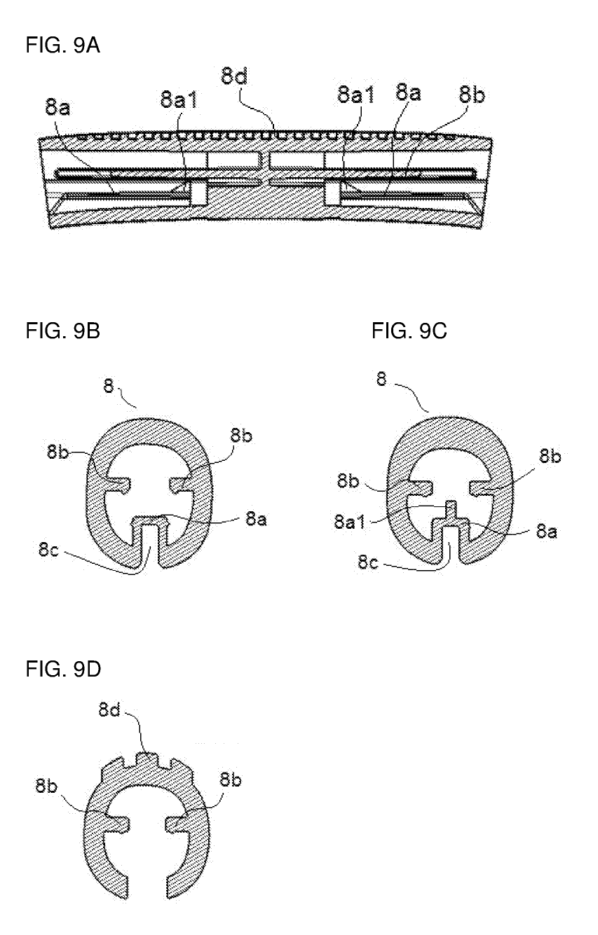

The guide portion 8a extends along an axis of the tubular portion 8 to guide the first body portion 4b and the second body portion 9b. More specifically, a bottom wall of the tubular portion 8 is formed in a concave shape protruding toward the inside of the tubular portion 8. The guide portion 8a is the inner surface of the bottom wall having a predetermined width corresponding to that of the first engaging portion 4b1 of the first body portion 4b and the second engaging portion 9b1 of the second body portion 9b to guide the first and second base portions 4, 9 during insertion of the first and second base portions 4, 9 into the tubular portion 8. Further, an outer surface of the bottom wall of the tubular portion 8 has a groove 8c for providing a space to wrap the outer cover portion 6, as shown in FIGS. 8A-8B and 9B-9C.

As shown in FIGS. 8B, 9A, and 11C, the guide portion 8a includes two fitted portions 8a1 in which one of the two fitted portions 8a1 is formed on one side of the guide portion 8a and another of the two fitted portions 8a1 formed on another side of the guide portion 8a. The fitted portions 8a1 are protrusions protruding from a surface of the guide portion 8a having an inclined surface so that when the first and second fitting end portions 4c, 9c are inserted into the tubular portion 8, the inclined surface of the first and second fitting end portions 4c, 9c slide over the inclined surface of the fitted portions 8a1 and the hole portions 4c1, 9c1 engage the fitted portions 8a1. Thus, the tubular portion 8 is engaged with the first and second base portions 4, 9.

As shown in FIGS. 8A-8B and 9A-9D, the auxiliary guide portions 8b are formed on an inner side surface of the tubular portion 8 along the axis of the tubular portion 8 to guide the first auxiliary guided portion 4b2 of the first body portion 4b and the second auxiliary guided portion 9b2 of the second body portion 9b.

As shown in FIGS. 8A-8C, the plurality of ribs 8d is formed on an exterior surface of an upper portion of the tubular portion 8. The plurality of ribs 8d allows the handle portion 11 to have a curved shape wherein a center of the tubular portion 8 is curved outwardly relative to the two ends of the tubular portion 8, while maintaining sufficient rigidity for usage and reducing the material cost. The curved shape increases the aesthetic of the assist grip.

The cushioning portion 7 is arranged to surround the tubular portion 8.

The outer cover portion 6, made of for example leather, is arranged to cover the cushioning portion 7.

As shown in FIG. 2, the ring portion 5 is formed to have a circumference slightly greater than that of the tubular portion 8 covered with cushioning portion 7 and the outer cover potion 6 so that the ring portion 5 covers the ends of the tubular portion 8 covered with cushioning portion 7 and the outer cover potion 6. Further, the ring portion 5 has a hole having a shape corresponding to that of the first and second body portions 4b, 9b to guide the first and second base portions 4, 9 when inserting therein.

Next, the assembly of the assist grip of the present embodiment is explained.

First, as shown in FIG. 2, the first base portion 4 is assembled. The spring 3 is arranged between the leg portions 1e of the hinge portion 1, and the hinge portion 1 is housed inside the concave portion 4a1 of the first fixed end portion 4a. Then, the shaft portion 2 is inserted through the shaft hole 1e1 of the leg portions 1e of the hinge portion 1 from the shaft through-hole 4a2 of the first fixed end portion 4a into the shaft hole 4a3 and press fitted to rotatably support the hinge portion 1 to the first base portion 4.

Second, as shown in FIG. 2, the second base portion 9 is assembled. The damping device 10 is arranged between the leg portions 1e of the hinge portion 1, and the hinge portion 1 is housed inside the concave portion 9a1 of the second fixed end portion 9a. Then, the shaft portion 2 is inserted through the shaft hole 1e1 of the leg portions 1e of the hinge portion 1 from the shaft through-hole 9a2 of the second fixed end portion 9a into the shaft hole 9a3 and press fitted to rotatably support the hinge portion 1 to the second base portion 9.

Third, as shown in FIG. 12, the handle portion 11 is assembled by covering the tubular portion 8 with the cushioning portion 7 and the outer cover portion 6. An adhesive is used for adhering the tubular portion 8 the cushioning portion 7, and the outer cover portion 6. Further, the outer cover portion 6 is stitched onto the cushioning portion 7 and the ring portions 5 are arranged to cover the ends of the tubular portion 8 covered by the cushioning portion 7 and the outer cover portion 6, as shown in FIGS. 1-2.

Fourth, the first and second fitting end portions 4c, 9c of the first and second base portions 4, 9 are inserted into the ends of the handle portion 11. The guide portion 8a and the auxiliary guide portion 8b of the tubular portion 8 guide the first and second base portions 4, 9. Each of the first and second fitting end portions abuts the respective fitted portion 8a1, and elastically deforms upward to slide over the fitted portion 8a1. Each of the hole portions 4c1, 9c1 engages the respective fitted portion 8a1, thereby, completing assembly of the assist grip of the present embodiment.

Finally, each of the hinge portions 1 is rotated in relative to the first and second fixed end portions 4a, 9a to expose the plate portion 1a of the hinge portion 1. The assist grip of the present embodiment is attached to the wall of the compartment of the automobile through an attaching member, for example, a screw, through a through-hole of each of the plate portion 1a, as shown in FIGS. 7A and 7B.

According to the aforementioned structures, the first and second fixed end portions 4a, 9a having first and second fitting end portions 4c, 9c formed at the ends respectively can fit to the respective fitted portions 8a1 formed in the tubular portion 8 of the handle 11. Thereby, the assembly performance is increased, the manufacturing cost is reduced and the fitting is firm.

Further, the assist grip of the present embodiment has a core-out shape wherein the tubular portion 8 is hollow and the first and second base portions 4, 9 are formed so that after the first and second base portions 4, 9 are assembled to the tubular portion 8, there is space inside the assist grip of the present embodiment as shown in FIGS. 4A, 6A, and 11C. Such structure allows the assist grip of the present embodiment to be formed from injection molding, thereby, an expensive molding process such as gas-assisted molding is not required. Because the gas-assisted molding is not required for molding the assist grip of the present embodiment, the manufacturing cost is reduced. Further, the core-out shape of the assist grip of the present embodiment allows to avoid issues such as a generation of voids and air bubbles during the molding process of the assist grip of the present embodiment and to reduce the material cost.

The above description simply illustrates the principle of the invention. Furthermore, a great number of modifications and alterations are possible for those skilled in the art, and the invention not being limited to the heretofore illustrated and described exact configurations and applications, all corresponding modification examples and equivalents are deemed to be within the scope of the invention defined by the attached claims and their equivalents.

What is claimed is:

1. An assist grip comprising:
an outer tubular portion having first and second fitted portions;
a first fixed end portion having a first body portion inserted into one end of the outer tubular portion and a first fitting end portion extending from the first body portion to engage the first fitted portion of the outer tubular portion; and
a second fixed end portion having a second body portion inserted into another end of the outer tubular portion and a second fitting end portion extending from the second body portion to engage the second fitted portion of the outer tubular portion.

2. An assist grip according to claim 1, wherein the outer tubular portion further comprises a guide portion formed inside thereof extending from the one end toward the another end along an axis of the outer tubular portion, and
the first or second body portion further comprises an engaging portion corresponding to the guide portion.

3. An assist grip according to claim 2, wherein the first and second fitted portions are formed on the guide portion.

4. An assist grip according to claim 3, wherein the first and second fitted portions are disposed at predetermined positions corresponding to the first and second fitting end portions.

5. An assist grip according to claim 4, wherein the first and second fitting end portions each has a hole portion corresponding to the first and second fitted portions of the outer tubular portion.

6. An assist grip according to claim 2, wherein the outer tubular portion further comprises a pair of auxiliary guide portions formed inside thereof extending along the axis of the outer tubular portion from the one end toward the another end of the outer tubular portion, and
the first or second body portion includes an auxiliary engaging portion corresponding to the auxiliary guide portion so that the pair of auxiliary guide portions guides the first or second body portion when the first or second body portion is inserted into the outer tubular portion.

7. An assist grip according to claim 1, wherein the first body portion further comprises a first engaging portion having a pair of legs extending downward, the pair of legs spaced from each other to have a predetermined space therebetween,
the outer tubular portion further comprises a guide portion to guide the first body portion, the guide portion having a convex shape protruding upwardly from a bottom of the outer tubular portion toward inside of the outer tubular portion and extending along an inserting direction of the first body portion, and
the guide portion has a predetermined width corresponding to that of the predetermined space between the pair of legs so that the first engaging portion slides along the guide portion during an insertion of the first body portion into the outer tubular portion.

8. An assist grip according to claim 7, wherein the first body portion further comprises a first auxiliary engaging portion arranged above the first engaging portion to have a predetermined space between the first engaging portion and the first auxiliary engaging portion, the first auxiliary engaging portion protruding in a direction perpendicular to the pair of legs of the first engaging portion and extending along the inserting direction,
the outer tubular portion further comprises an auxiliary guide portion to guide the first body portion, the auxiliary guide portion protruding from an inner side surface of the outer tubular portion and extending along the inserting direction, and
the auxiliary guide portion has a predetermined width corresponding to that of the predetermined space between the first engaging portion and the first auxiliary engaging portion so that the auxiliary guide portion guides the first body portion during the insertion of the first body portion into the outer tubular portion.
